(19) United States
(12) Patent Application Publication
(10) Pub. No.: US 2020/0358644 A1
(43) Pub. Date: Nov. 12, 2020

(54) SYSTEM FOR THE BLIND DEMODULATION OF DIGITAL TELECOMMUNICATION SIGNALS

(71) Applicant: Avantix, Aix-en-Provence (FR)

(72) Inventor: Thomas COURTAT, Paris (FR)

(21) Appl. No.: 16/958,785

(22) PCT Filed: Dec. 28, 2018
(86) PCT No.: PCT/FR2018/053556

§ 371 Date: Jul. 16, 2020

(30) Foreign Application Priority Data
Dec. 29, 2017 (FR) 1701417
Dec. 29, 2017 (FR) 1701418
Dec. 29, 2017 (FR) 1701419
Feb. 16, 2018 (FR) 1800149

(51) Int. Cl. H04L 27/26; H04L 1/00; H04L 25/02

(52) U.S. Cl. CPC H04L 27/2676; H04L 25/0238; H04L 1/0038

(57) ABSTRACT

The present invention concerns a system for the blind demodulation of a linearly modulated digital telecommunication signal and comprising modules allowing the estimation, monitoring of the temporal variations and corrections in the value of the phases, amplitudes, frequencies, time offsets and a set of compensation filters of the propagation channel, characterized in that it comprises at least one hardware or hardware and firmware architecture comprising memories and one or more processing units for implementing a network of specific calculation blocks connected to each other, including a block for the blind synchronization of the signal allowing the estimation, monitoring and compensation of the delay of the signal and also making it possible to adapt the processing rate of the downstream chain (of the demodulation system) to the reduced cadence of one sample per symbol, a first block incorporates at least one module making it possible to estimate at least one of the parameters of the observed signals in order to subsequently evaluate the other parameters of the observed signals, by other calculation blocks of the network, at least a second specialized calculation block incorporates a decision module in order to calculate an error signal and retro-propagate the calculated errors to each of the preceding residual blocks.

### TECHNICAL FIELD OF THE INVENTION

The present invention generally relates to a digital telecommunications signal processing system, and in particular a system for optionally blind and real-time demodulation of linearly modulated, mono-polarized, or bipolarized telecommunication signals, transmitted over a distorted and robust channel with various deficiencies in the transmission chain (synchronization, frequency drift, phase noise, etc.).

### TECHNOLOGICAL BACKGROUND OF THE INVENTION

In the field of digital telecommunications, a demodulation of a signal is carried out by a demodulation device to reconstitute a so-called baseband signal from the observation of a signal that is modulated and possibly distorted by the imperfections in the transmission chain and of a propagation channel. Blind demodulation, more particularly, aims at demodulating a signal without using previously known pilot sequences.

Blind demodulation of a digital telecommunication signal in linear modulation can be performed based on two types of signals:
signals referred to as “mono-channel” or “mono-polarized”, that are conventional signals in which an information flow is transmitted over the medium; and
“multi-channel” or “bipolarized and/or multipolarized” signals or XPIC (an acronym referring to the “cross-polarization interference canceler” demodulation technique), which are made up of two multiplexed signals over two polarizations of the electromagnetic wave.

A signal equalization function is designed to be able to best invert the channels and compensate for transmission imperfections. Such a function requires knowledge of numerous parameters or characteristics (frequency, amplitude, equalization filters, etc.) of the linearly-modulated signal. In a cooperative or “non-blind” transmission mode, known sequences of the transmitter and the receiver are transmitted regularly and make it possible to regulate the equalizer. However, in a context of blind transmission, no sequence is known and an equalization function is difficult to find.

The documents (S. Barembruch, “Méthodes approchées de maximum de vraisemblances pour la classification et identification aveugles en communications numériques” [“Approximate maximum likelihood methods for blind classification and identification in digital communications”], dissertation, Telecom ParisTech, 7 Mar. 2011) and (E. Punskaya, “Sequential Monte Carlo methods for digital communications”, dissertation, Cambridge University, 2003) present two similar methods based on the EM (“Expectation Maximization”) algorithm enabling blind demodulation of telecommunication signals. However, these approaches, albeit of reduced complexity, do not make it possible to process high-rate signals in real time; they are focused on the compensation of the propagation channel and do not make it possible to compensate other signal distortions (synchronization, phase, carrier drift . . . ). They do not make it possible to monitor temporal variations in the parameters. They also do not make it possible to process signals over several polarizations.

One of the aims of patent FR3030964 is to propose methods enabling the blind separation and demodulation of two linearly modulated, single-channel, frequency-superimposed telecommunication signals using an expectation maximization algorithm and particle filtering techniques. While this method makes it possible to monitor the temporal variations of the parameters, it is still too demanding in terms of computing time to be able to monitor a high-rate signal in real time and for large orders of modulation.

### GENERAL DESCRIPTION OF THE INVENTION

The aim of the present invention is to overcome some of the disadvantages of the prior art by proposing a system making it possible to optimize and facilitate the potentially blind demodulation of mono-polarized or bipolarized telecommunication signals and to enable real-time implementation.

For this purpose, the present invention relates to a system for the blind demodulation of a linearly modulated digital telecommunication signal and comprising modules allowing the estimation, monitoring of the temporal variations and corrections in the value of the phases, amplitudes, frequencies, time offsets and a set of compensation filters of the propagation channel, characterized in that it comprises at least one hardware or hardware and firmware architecture comprising memories and one or more processing units for implementing a network of specific calculation blocks connected to each other, including
a block for the blind synchronization of the signal allowing the estimation, monitoring and compensation of the delay of the signal and also making it possible to adapt the processing rate of the downstream chain (of the demodulation system) to the reduced cadence of one sample per symbol,
a first block incorporates at least one module making it possible to estimate at least one of the parameters of the observed signals in order to subsequently evaluate the other parameters of the observed signals, by other calculation blocks of the network,
at least a second specialized calculation block incorporates a decision module in order to calculate an error signal and retro-propagate the calculated errors to each of the preceding residual blocks (“propagate”, “update”).

According to another particular feature, the parameter of the first block is the amplification rate, and the system comprises an additional specialized block connected to the outputs from the first block and to the inputs for the decision block, this additional block executing at least one frequency estimation module to determine the frequencies of the blind-transmitted signals and/or at least one phase module to determine the phase values of said signals.

According to another particular feature, the phase module can be placed in an additional calculation block connected to the outputs from the block for calculating the frequency of the additional block.

According to another particular feature, the system comprises an additional specialized block of the network between the synchronization block and the first calculation block, said additional block executes the estimation of at least one filter making it possible to correct all or part of the distortion induced by the propagation channel.

According to another particular feature, the synchronization block module is configured to receive as input a sampled complex signal flow with at least two samples per symbols and store these samples in an internal memory buffer in order to deliver at each symbol time an output of the input signal to the downstream block of the network (for example, the second block, the first block or the additional block).

According to another particular feature, at least one filter module (F or G) of the additional block is initialized by the following initialization operations:
F=complex vector of size N_{F}
X=complex FIFO of size N_{F}
   wherein the initialization parameters, stored in a memory of the filter module, are:
N_{F} is a whole number
μ a vector of real numbers of size N_{F}.

According to another particular feature, at least one amplification module of the first block is initialized by the following initialization operations:
a=_a_
X=complex FIFO of size_N_
μ=_μ_
   wherein the initialization parameters, stored in a memory of the module of the first block, are:
_a_ is an initial amplification value
_N_ is a whole number
_μ_ is a real number.

According to another particular feature, the frequency estimation module of the additional block (to the first block) is initialized by the following initialization operations:
f=_f_
η=e^{2πjf}
ρ=1.0
X=complex FIFO of size_N_
μ=_μ_
   wherein the initialization parameters, stored in a memory of the module of the additional block (to the first block), are:
_f_ is a real number coding an initial estimation of the frequency
N is a whole number
_μ_ is a real number.

According to another particular feature, the phase value estimation module of the additional block is initialized by the following initialization operations:
φ=−_φ_
ρ=e^{2πjφ}
μ=_μ_
   wherein the initialization parameters, stored in a memory of the module of the additional block (to the first block), are:
_φ_ is a real number
_N_ is a whole number
X=complex FIFO of size_N_
_μ_ is a real number.

According to another particular feature, upon initialization of the system, parameters denoted θᵢ are provided by default by a memory of the system, allowing in the first moments, called the convergence phase, the convergence of the θᵢ on relevant values; then when the system reaches a defined vicinity of the parameters θᵢ, the system enters (implicitly) into the phase referred to as production or monitoring, the outputs of the demodulator system then are reliable and applicable to a use device or to other hardware or software or firmware elements making it possible to finalize the demodulation.

According to another particular feature, processing blocks (H-N1; V-N1) of at least one of two channels receives each of the two synchronized input signals (x₁^{(h)}; x₁^{(v)}) resulting from the synchronization block (for example, representing a sampling of each channel respectively, in order to generate the output signals x₁^{(h)} and x₁^{(v)}), the signals x₃^{(h)} and x₃^{(v)} being representative of a correction applied to each signal x₀ by the respective output signals x₂^{(h)} and x₂^{(v)}, of each of the filters G of each channel, each emulated by a processing block (H-N2; V-N2), the signals x₃^{(h)} and x₃^{(v)} are sent over the cascades in series of the processing blocks (H-N4; V-N4), (H-N5; V-N5) and (H-N6; V-N6) of each channel, each emulating the signal indicating amplification of the channel (ampli), for the block (H-N4; V-N4), respectively the frequency (fq) of the channel for the block (H-N5; V-N5) and respectively the phase (φ) of the channel for the block (H-N6; V-N6).

According to another particular feature, each respective output y^{h}, y^{v} of each processing block (H-N6; V-N6) emulating the correction of the phase of each channel H and V, is sent over each decision block (H-NL; V-NL) of each channel and over each of the respective inputs of the retro-propagation circuit of at least two errors (e^{h} and e^{v}) through the “mirror” blocks, which enable the calculation on the fly of the increments of the different parameters of the blocks of the chain, the system comprising several modules for processing a plurality of observations of each input signal (xᵢ), each associated with a mirror or residual “Update” block for each phase, frequency, ampli parameter, and a corresponding mirror or residual “Propagate” block for each phase, frequency and amplification parameter.

According to another particular feature, the output Z^{h}, Z^{v} of each decision block is also sent to a pair of multipliers, receiving respectively one from the phase block and the other from the frequency fq block (for example, corrective factors representing the instantaneous frequency). The output of the last multiplier of each channel is sent over each of the filters G of each channel, each emulated by a processing block for each channel.

According to a variant, the invention relates to a real-time method for the blind demodulation of digital telecommunication signals, based on the observation of a sampled version of this signal.

The method applied in a certain scheme makes it possible in particular to demodulate a single-channel signal of linear modulation by compensating: the amplification of the signal, its phase, its carrier leak, the effects of the propagation channel.

The method applied according to another scheme makes it possible in particular to demodulate a dual-channel signal and to separate the two components thereof by compensating: the amplification of the signals, their phases, the carrier leaks, the effects of the propagation channel and the effects of the propagation co-channel (leak from one polarization to the other and vice-versa during the propagation of the signal).

The method described here can be considered overall to be a sequence of blocks of MIMO (multi inputs, multi outputs) called “specialized neurons”, each block (i) executing a basic parameterized processing by a set θᵢ. If all the θᵢ of the chain are correctly set, the chain proceeds with the effective demodulation of the signal. If the θᵢ are unknown, the chain enables the in-line learning of the relevant values for each θᵢ. On initialization of the system, θᵢ are provided by default by a memory. In the first moments, the system enables the convergence of the θᵢ on relevant values; this phase is called the convergence phase; the demodulated signal produced at the output is thus not reliable. When the system reaches the vicinity of the parameters θᵢ, the “production” or “monitoring” phase is entered. The demodulator outputs are then reliable and usable.

The outputs of the demodulator are then reliable and, together with the demodulation of the signal, the system continues with the variation of the parameters of the system. The system does not explicitly shift from one mode to the other, the second phase takes place as a continuation of the first.

The method of the invention can comprise the following steps:
acquisition by a sampling of a first plurality of the signal in order to each constitute an input of a network of L processing blocks, also referred to here as “specialized neurons” or simply “neurons”, each neuron being simulated by the outputs of the preceding block, the first plurality of the signal being input into the first block simulating a first neuron in the network in order to generate a plurality of outputs of the first block; each neuron Fᵢ being simulated by the outputs of an upstream chain Gᵢ and stimulating a downstream chain Hᵢ; each set of samples passes through the same processing chain;
the outputs of the last blocks of the network ideally correspond to the demodulated symbols;
addition of a nonlinearity to each of the outputs of the last block of the network making it possible to calculate an error signal and propagation of this error in the reverse direction of the processing chain (“retropropagation”);
estimation, upon receipt by each neuron (i) of the error of a corrective term δθᵢ and updating in each block of the value of the parameter θᵢ according to θᵢ+=δθᵢ.

According to another particular feature, each neuron in the network specifically performs:
a processing of a “Next” function, implemented and executed in a processing logic sub-block (Fᵢ^{(N)}), in order to generate outputs based on a plurality of observations of the signal and to transmit them to the processing block of the following neuron in the network; this function is generally written in the form (X_{i+1,0}, . . . , X_{i+1,m}_{ᵢ₊₁}₋₁)=next(X_{i,0}, . . . , X_{i,m}_{ᵢ}₋₁) with mᵢ the number of inputs and mᵢ₊₁ the number of outputs of Fᵢ^{(N)}, which corresponds to the number of inputs of Fᵢ₊₁^{(N)};
a processing of a “Propagate” function, implemented and executed in a “Propagate” logic sub-block (Fᵢ^{(P)}) in order to calculate the errors (e_{i+1,0}, . . . , e_{i+1,m}_{ᵢ₊₁}₋₁) provided by the block Fᵢ₊₁^{(P)} or by (e_{L-1,0}, . . . , e_{L-1,N-1})=(e₀, . . . , e_{N-1}) with eⱼ=(̅z̅ⱼ̅−̅y̅ⱼ̅)̅ at the chain end, i.e., at the input F_{L-1}^{(P)}; for the ith neuron, this function is generally written in the form (e_{i,0}, . . . , e_{i,m}_{ᵢ}₋₁)=propagate(e_{i+1,0}, . . . , e_{i+1,m}_{ᵢ₊₁}₋₁)
a processing of an “Update” function, implemented and executed in an “Update” logic sub-block (Fᵢ^{(U)}), in order to calculate the corrective parameters δθᵢ to be applied to the current value of the internally stored parameter θᵢ from the errors (e_{i+1,0}, . . . , e_{i+1,m}_{ᵢ₊₁}₋₁) returned by the sub-block Fᵢ₊₁^{(P)}; this function is generally written in the form δθᵢ=update(e_{i+1,0}, . . . , e_{i+1,m}_{ᵢ₊₁}₋₁).

According to another particular feature, each neuron comprises at least one implementation and execution of a sequence of elementary processes of the form:
the sub-block Fᵢ^{(N)} performs (X_{i+1,0}, . . . , X_{i+1,m}_{ᵢ₊₁}₋₁)=next(X_{i,0}, . . . , X_{i,m}_{ᵢ}₋₁), XᵢⱼϵK^{q}^{ᵢⱼ}
   with qᵢⱼ a whole number and K the real number space or complex number space
the sub-block Fᵢ^{(p)} performs (e_{i,0}, . . . , e_{i,m}_{ᵢ}₋₁)=propagate(e_{i+1,0}, . . . , e_{i+1,m}_{ᵢ₊₁}₋₁)
the sub-block Fᵢ^{(U)} performs δθᵢ=update(e_{i+1,0}, . . . , e_{i+1,m}_{ᵢ₊₁}₋₁)

According to another particular feature, the addition of the nonlinearity at the output of the last block (Hᵢ^{(N)}) of the network is executed by the function:

zⱼ=NL(yⱼ)

wherein
zⱼ is the outgoing signal from a decision-making device in the last block
yⱼ is an equalized or demodulated sample
the decision-making block being defined by the comparison of the result obtained by the output y of the phase block with a finite constellation of possible results stored by the decision-making block, and deciding to take, from the possible results, the one for which the distance with the representative point of the output y is the smallest.

According to another particular feature, the retropropagation of the calculated errors is obtained by the following processes, implemented and executed by an algorithm for retropropagation of the error:
initialization of the retropropagation in the form
   for 0≤k<N, e_{L,k}=z̅ₖ̅−̅y̅ₖ̅
Propagation of the error by the sub-neuron Fᵢ^{(P)}) in the function (e_{i,0}, . . . , e_{i,m}_{ᵢ}₋₁)=propagate (e_{i+1,0}, . . . , e_{i+1,m}_{ᵢ₊₁}₋₁) according to the calculations

$$∀ 0 \leq j < {m}_{i} , {e}_{i , j} = {\sum }_{k} {e}_{i + 1 , k} \cdot \frac{\partial {F}_{i , k}}{\partial {x}_{i , j}}$$

According to another particular feature, the updating of the internal parameters θᵢ of each neuron Fᵢ is obtained in the sub-neuron Fᵢ^{(U)} by the processes, implemented and executed in the function δθᵢ=update (e_{i+1,0}, . . . , e_{i+1,m}_{ᵢ₊₁}₋₁) according to:
Calculation of Δᵢ:

$$For 0 \leq j < {M}_{i + 1} {D}_{i , j} = {e}_{i + 1 , j} \cdot \frac{\partial {F}_{i , j}^{( N )}}{\partial {θ}_{i}}$$

Δᵢ=Σᵢ D_{i,j}
Updating of θᵢ:
θᵢ+=2μR(Δᵢ) if θᵢ is in an R vector space
θᵢ+=2μΔᵢ if θᵢ is in a C vector space
With −μᵢ a real parameter called “learning rate”
δθᵢ is the corrective parameter of the parameter θᵢ
Dᵢⱼ is an intermediate quantity of auxiliary calculations that can be temporarily stored.

According to another particular feature, as the samples input into the system are processed by the different sub-blocks, the arbitrarily initialized values of the different θᵢ converge on values making the demodulation effective.

According to another particular feature, the specialized neuron network constitutes a compatible sequence of blocks of MIMO (“multi inputs, multi outputs”) type.

According to another particular feature, the method further comprises the storage, by at least one memory buffer, of the plurality of inputs and, in at least one other buffer, of the plurality of outputs of each specialized neuron of the network.

According to another particular feature, on initialization of the computing system constituting a demodulator, θᵢ are provided by default by a memory of the system in the first moments of execution of the method, the system enables the convergence of the θᵢ on relevant values.

Another aim is to overcome one or more of the disadvantages of the prior art relating to implementing or executing a method for the blind demodulation of digital telecommunication signals in computing or electronic hardware. The method enables the separation of the components of a dual-channel signal received after mixing.

This aim is achieved by a computer program product implemented on a memory medium, capable of being executed within a computing processing unit, either by hardware or a combination of hardware and firmware, and comprising instructions for executing a method according to any one of the preceding claims.

Another aim is to overcome one or more of the disadvantages of the prior art relating to the application of a method for the blind demodulation of digital telecommunication signals with linear modulation.

This aim is achieved by a use in a system for the blind demodulation of a telecommunication signal, the system comprising at least one network of specialized neurons each respectively defining a filtering by a first specialized neuron, an amplification gain by a second specialized neuron, a correction of the frequency of the signal by a third specialized neuron and the correction of the phase value of the signal by a fourth specialized neuron; characterized in that the method according to any one of the preceding claims is executed in order to determine the parameters (or characteristics) of the blind-transmitted signal. If these characteristics are not fixed constants of the signal of interest, but processes which vary over time, the system monitors the variations in these parameters.

Other particular features and advantages of the present invention are detailed in the following description.

### DESCRIPTION OF THE ILLUSTRATIVE FIGURES

Other special features and advantages of the present invention will become clear from reading the following description, made in reference to the appended drawings, wherein:

FIG. 1 schematically depicts the integration of a “specialized neuron” Fᵢ in a chain of upstream neurons (Gᵢ) and in a chain of downstream neurons (Hᵢ) of a real-time method for the blind demodulation of digital telecommunication signals to be implemented in at least one embodiment of the invention;

FIG. 2a schematically depicts the processes executed by a module of the calculation or processing blocks (or neuron) M-i of the network, according to an embodiment of the invention; and FIG. 2b schematically depicts in more detail the processes executed by the named specialized neuron of the network, according to one embodiment of the invention;

FIG. 3 schematically depicts a processing chain of a blind demodulator of single-channel type, according to one embodiment of the invention;

FIGS. 4 and 5 schematically depict a processing chain of a blind demodulator of multi-channel type (comprising two channels), enabling respectively the generation and the transmission to the following block of a plurality of outputs from the preceding block and the retro-propagation of the calculated errors depicted in FIG. 5.

The same references may designate identical or similar elements in the different figures.

### DESCRIPTION OF PREFERRED EMBODIMENTS OF THE INVENTION

In the following, it will be noted that each module or sub-module or block (or in other words processing or calculation block) of the demodulation system comprises at least one computing (or electronic) machine and one software or code executable by the machine to define one or more parameter(s) obtained by calculating one or more analytical function(s) specific to a module or sub-module or block. Thus, the processing of one or more function(s) can be implemented and executed by each module or sub-module or block. “Implemented and executed” is intended to mean either the execution of a program corresponding to the mathematical functions or formulae (explained in the text) by computing hardware (such as a microprocessor and a memory), or by hardware or a combination of hardware and firmware.

On the other hand, the person skilled in the art may optionally be able to use the other three applications (with the filing numbers FR1701417, FR1701418 and FR1701419) filed under priority internal to the present application, by the present applicant in order to assess any possible functional and/or structural characteristics, which are not, or are insufficiently, detailed in the present application. In other words, the entirety of the other three applications (description, claims and drawings) is, where applicable (according to the law in force), incorporated into this application by reference.

The present invention relates to a system for the blind demodulation or searching of telecommunication signals, based on the observation by sampling of a signal; this signal corresponds to the reception of a linear-modulation signal that has undergone deformations during its transmission. The processes of the demodulator are parameterized in particular by: equalization coefficients, a correction value of the phase ((p), of the amplitude of the signal (Ampli or A), of the effect of the frequency (f) and the time offset of signal (i).

In some embodiments, the blind demodulation system of the present invention comprises at least one specific processing block enabling the correction of the different distorting elements of a digital transmission chain, such as the correction of the synchronization error, the correction of the propagation channel and the equivalent channel induced by the imperfections of the acquisition boards or electronic components, the correction of the signal amplification, the correction of the phase error, of the frequency drift, of the phase noise and of the instabilities in frequency of the oscillators employed. In the bipolarized case, the present invention can also make it possible to compensate the signal leaks from one channel to the other.

In some embodiments, the blind demodulation system comprises at least one hardware or hardware and firmware architecture comprising memories and one or more processing units for implementing a network of specific calculation blocks connected to each other, including
a block for the blind synchronization of the signal allowing the estimation, monitoring and compensation of the delay of the signal and also making it possible to adapt the processing rate of the downstream chain (of the demodulation system) to the reduced cadence of one sample per symbol,
a first block incorporates at least one module making it possible to estimate parameters of the observed signals in order to subsequently evaluate the other parameters of the observed signals, by other calculation blocks of the network,
at least a second specialized calculation block incorporates a decision module in order to calculate an error signal and and retro-propagate the calculated errors to each of the preceding residual blocks (“propagate”, “update”).

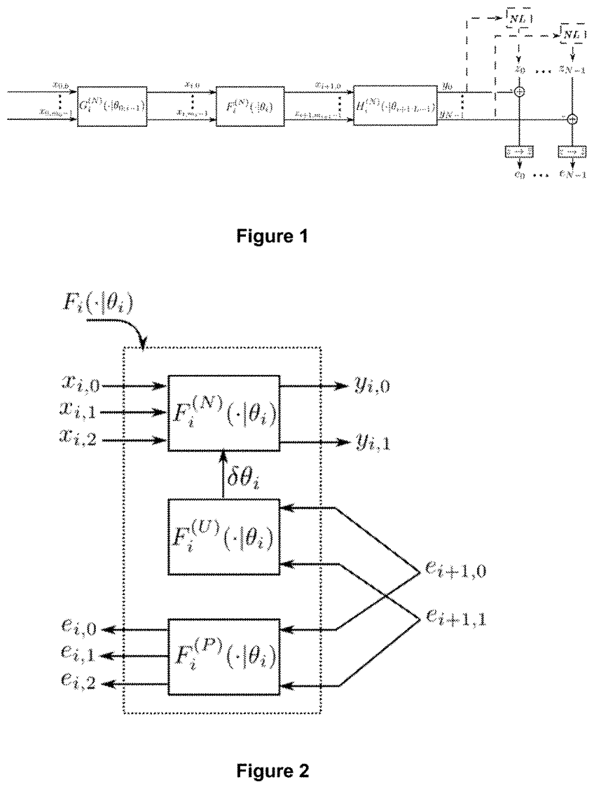

In some embodiments, the first block and/or the additional blocks of the first block (for example, the amplification module, the frequency module and/or the phase value module) and the additional block(s) (for example, the Filter F and/or G module) of the system can be arranged according to the configuration in FIG. 2a, in which the blocks are denoted generically by M-i with i an indexing value containing a certain number of internal states (which can be scalar or vector values, whole numbers, real numbers or complex numbers), in particular including a parameter θᵢ (which can be a vector of real or complex parameters), parameterizing the processes performed by the module of said block. The Module M-i can be broken down into at least three sub-modules:
N-i, which encapsulates (or implements) a “next” function,
P-i, which encapsulates (or implements) a “propagate” function and
U-i, which encapsulates (or implements) the update function.

The grouping of sub-modules P-i and U-i is denoted B-i.

Internally, the update( ) function calculates the value of an increment δθᵢ to apply to the current value of the internal parameter vector θᵢ based on θᵢ=θᵢ+δθᵢ.

The input values of sub-module N-i are the values xᵢ₋₁ produced by the module N−(i−1). The input values of sub-module B-i are the values eᵢ produced by the module B-(i+1).

The sub-module N-i produces the value x, and the sub-module P-i produces the value eᵢ₋₁

It will be noted that the inputs xᵢ₋₁ and eᵢ can be real or complex numbers or real or complex vectors. They can be the result of multiplexing of results from several sub-modules.

In some embodiments, the synchronization block module is configured to receive as input a complex signal flow with at least two samples by symbols and store these samples in an internal memory buffer in order to deliver at each symbol time an output of the input signal to the first block in the network. In some embodiments, the module of the synchronization block implements a “next” function in the form y=next( ), in which the input values needed to perform the function can be moved into at least one buffer or internal memory buffer. In addition, since this module was placed at the beginning of the processing chain of the system, a definition and an implementation of a “propagate” function may not be necessary.

In some embodiments, the “decision” module of the second block does not implement the Propagate and Update functions.

In some embodiments, the system runs at a symbol cadence.

In some embodiments, for each signal symbol, a sequence of next( ) functions encapsulated (or integrated) in the different modules are successively applied to the output of the synchronizer (or blind signal synchronization block) to produce at the end of the system processing chain, an output y.

In some embodiments, a decision function is applied at the output y (for example by the second block of the system). In a blind context, with known modulation, this decision function may be, for example, a slicer, which has a complex number associating the symbol of the closest modulation. In a cooperative context, the decision function returns the previously known value of the symbol. In some embodiments, a mixed context may be provided for a multiplexing signal of known pilot symbols and unknown data symbols.

To this basic architecture of the demodulation system, a feedback loop can be added containing an additional filter (denoted G). This addition enables a greater robustness of the demodulation in the propagation channel. In some embodiments, the demodulation system may not comprise a filter module (F and/or G) of the additional block, in particular for signals obtained by optical fibers or satellite, since there is no (or little) echo or signal noise.

The output of the decision module (or slicer) may be denoted z. The quantity of error e may be defined by the formula: e=z̅−̅y̅. It may constitute the beginning of the feedback chain. The error e runs through the processing chain in the opposite direction, as shown, for example, in FIGS. 2a, 3 and 5. In each sub-module P-i, the propagate( ) function modifies the error received from the preceding module (in the opposite direction of the chain) before sending this error to the next module (in the opposite direction of the chain). The error received by a module is also used as an input of the update( ) function in the sub-module U-i, which updates the parameters of the processing module M_i.

The system can be implemented by software on a calculation device or by an electronic system. The different processing modules M_i can be pipelined.

Hereinafter, a FIFO memory buffer will be considered to be a vector. Thus, in some embodiments, the terms of the vector may go from the oldest (first index of the vector) to the most recent (last index of the vector) element of the FIFO buffer.

Thus, the notation [symbol] a|b [symbol] between two real or complex vectors of the same size denotes the sum of the product of their elements: [symbol] a|b [symbol] =Σ aᵢbᵢ.

In some embodiments, each calculation block in the network includes an initialization function, which can be implemented by at least one processor and at least one software or one executable code, in order to initialize the parameters of the module of each calculation block in the network (for example: amplification module, frequency module, phase value module, etc.).

In some embodiments, at least one filter module (F or G) of the additional block is initialized by the following initialization operations:
F=complex vector of size N_{F}
X=complex FIFO of size N_{F}
   wherein the initialization parameters, stored in a memory of the filter module, are:
N_{F} is a whole number
μ a vector of real numbers of size N_{F}.

In some embodiments, at least one amplification module of the first block is initialized by the following initialization operations:

a=_a_

X=complex FIFO of size _N_

μ=_μ_

wherein the initialization parameters, stored in a memory of the module of the first block, are:
_a_ is an initial amplification value
N is a whole number
_μ_ is a real number.

In some embodiments, the frequency estimation module of the additional block (to the first block) is initialized by the following initialization operations:
f=_f_
η=e^{2πjf}
ρ=1.0
X=complex FIFO of size _N_
μ=_μ_
   wherein the initialization parameters, stored in a memory of the module of the additional block (to the first block), are:
_f_ is a real number coding an initial estimation of the frequency
_N_ is a whole number
_μ_ is a real number.

In some embodiments, the phase value estimation module of the additional block (to the first block) is initialized by the following initialization operations:
φ=_φ_
ρ=e^{2πjφ}
μ=_μ_
   wherein the initialization parameters, stored in a memory of the module of the additional block (to the first block), are:
_φ_ is a real number
_N_ is a whole number
X complex FIFO of size _N_
_μ_ is a real number.

The present invention has the advantage of defining specific processing blocks allowing the correction of different distorting elements in a digital transmission chain, such as the correction of the synchronization error, the correction of the propagation channel and of the equivalent channel induced by the imperfections of the acquisition boards or electronic components, the correction of the signal amplification, the correct of the phase error, of the frequency drift, of the phase noise and of the instabilities in frequency of the oscillators employed. In the “dual-channel” case, the invention also makes it possible to compensate for signal leaks from one channel to the other induced, for example, by a poor alignment between the transmission and receiving antennas. Moreover, the present invention can make it possible to identify the optimal correction parameters and to follow their variation over time. The different corrections applied by the different modules of this invention also enable enhanced stability compared with feedback loops generally used in blind demodulation systems.

Furthermore, the present invention can make it possible to process, within the same system, the demodulation of blind signals and the demodulation of cooperative signals.

The present invention also has good robustness for phase noise in the “single-channel” assembly. It has the advantage of being robust for phase noise produced by the transmission and receiving oscillators in the “dual-channel” case; in particular, it does not require the frequency transposition oscillators to be synchronized for transmission or receiving. The invention also makes it possible to correct different frequency drifts and frequency instabilities on the different oscillators present in the transmission chain.

In some embodiments, the present invention enables the blind demodulation of a very high signal rate, in particular with high modulation orders.
Demodulation of a single-channel signal

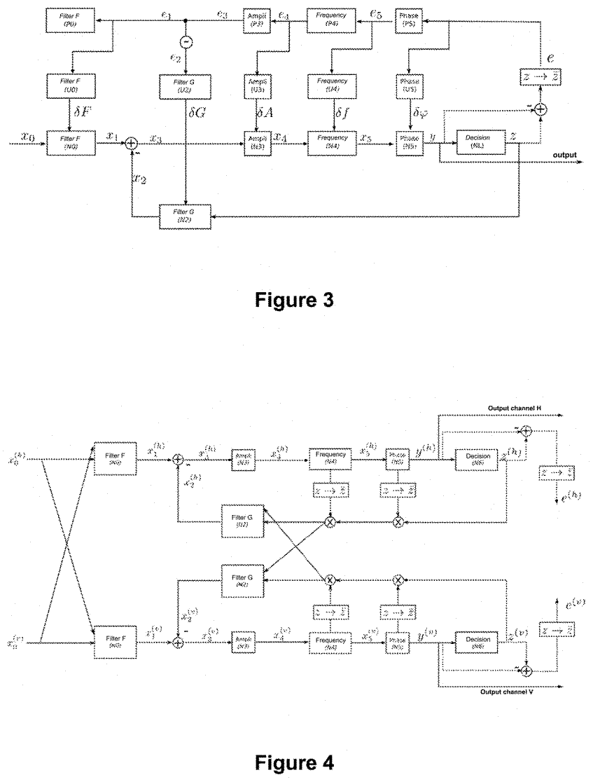

In some embodiments, the system for the blind demodulation of a single-channel signal may operate based on the schematic configuration in FIG. 3. The different modules and blocks of the demodulation system are shown in FIG. 3 by three sub-modules performing the next (sub-blocks (Nxx)), update (sub-blocks (Uxx)) and propagate (sub-blocks (Pxx)) functions. FIG. 3 schematically represents the sequence of operations performed for the creation, processing of a symbol and the updating of the parameters of each block.

In some embodiments, the processing of a stream of symbols or a signal is deduced from the schemes for processing a symbol. In this case, the different processing blocks can be in parallel, and the blocks can be arranged in a pipeline.

The synchronization module or the synchronization calculation block for the blind signal (NO) has a reference for the signal received. It stores the samples needed to form the complex output x₀. The values of x₀ are transmitted at the symbol rate of the signal to be demodulated. Therefore, reference will be made to a symbol. The output x₀ can be transmitted to the Filter F module, which performs the function (N1) to form an output x₁. The complex x₂ can be obtained by looping back the output of the decision block (NL) in a filter G (N2). The value x₂ can be subtracted from the value x₁ to form a complex output x₃, which can pass through the amplification module (N4) to form a complex output x₄. This value x₄ can then pass through the frequency module (N5) to form a complex output x₅, which then passes through the Phase module (N6) to form a complex y which constitutes the output of interest of the system and consists of a demodulated signal.

The symbol y is input to a decision-making body (for example a “slicer”). This module is programmed with the constellation of the modulation employed and returns, for every y, the complex value z of the point of the constellation closest to y.

The conjugated difference e=z̅−̅y̅ is calculated and constitutes the first error. This error will be retro-propagated through the different modules in the chain.

For each sub-module, an error is input to the propagate and update sub-modules. The propagate module calculates a new error that it sends as an input to the next module, the update module calculates an increment of the processing parameters for the current module. Thus, the error e is input into the sub-modules (P6) and (U6) of the phase module. (P6) calculates the value of the error e₅ from the error e. (U6) calculates the increment δφ to apply to the internal state φ of the phase module. The error e₅ is input into the sub-modules (P5) and (U5) of the Frequency module. (P5) calculates the error e₄ and (U5) calculates the increment δf on the internal parameter f of the frequency module. The different states of this module are updated accordingly. The error e₄ is input into the sub-modules (P4) and (U4) of the Ampli module. (P4) calculates the error e₃ and (U4) calculates the increment SA on the internal parameter A of the Amplitude module.

The opposite of the error of e₃ is calculated, i.e., e₂=−e₃, this error is input into the sub-module (U2), which calculates the increment δG to apply to filter G. The error e₃ is for the sake of homogeneity renamed e₁, for example, in FIG. 3, and input into the sub-modules (P1) and (U1) of the Filter F module. The sub-module (P1) calculates the error e₀ and (U1) calculates the complex vectorial increment δF on the internal parameter F of the Filter F module.

Lastly, the error e₀ is input into the sub-module (U0), which calculates the increment δτ to apply to the parameter T of the synchronizer module. The different states of this module are updated accordingly.

In some embodiments, the succession of the processing blocks, the retro-propagation of the error calculated through the “propagate” blocks and the increment of the different parameters of the blocks of the chain via the “update” blocks may be performed in a cascade and in a loop until the different parameters of the signal have been estimated as precisely as possible.

In some embodiments, each module of the calculation block of the network, by at least one hardware or a combination of hardware and firmware, may perform the following operations:

Filter F Module (1)
Initialization Parameters
N_{F} a whole number
μ a vector of real numbers of size N_{F}
Initialization
F=complex vector of size N_{F}
X=complex FIFO of size N_{F}
next(x)
X.append(x)
Return [symbol] F|X [symbol]
propagate(e)
Return e·F
update(e)
δF=2μ×(̅e̅·̅X̅)̅ (here x is the term-to-term product of two vectors)
F+=δF or F=F+δF

Filter G Module (2)
Initialization Parameters
N_{G} a whole number
μ a vector of real numbers of size N_{G}
Initialization
G=complex vector of size N_{G}
X=complex FIFO of size N_{G}
next(x)
X.append(x)
Return [symbol] G|X [symbol]
update(e)
δG=2μ×(̅e̅·̅X̅)̅ (here x is the term-to-term product of two vectors)
G+=δG

Ampli Module (3)
Initialization Parameters
_a_ an initial amplification value
_N_ a whole number
a real number
Initialization
a=_a_
X=complex FIFO of size_N_
μ=_μ_
next(x)
X.push(x)
Return a×x
propagate(e)
Return a×e
update(e)
Note: The size of FIFO X was selected to be consistent with the size of the error vector e
δa=2μR( [symbol] X|e [symbol] )
a+=δa

Frequency Module (4)
Initialization Parameters:
_f_ a real number coding an initial estimation of the frequency
_N_ a whole number
_μ_ a real number
Initialization
f=_f_
η=e^{2πjf}
ρ=1.0
X=complex FIFO of size _N_
μ=_μ_
next(x)
X.append(x)
Return x·ρ
ρx=η
propagate(e)
Return e·ρ
update(e)
Note: The size of the FIFO X was selected to be consistent with the size of the error vector
δf=4πμI(ρ· [symbol] X|e [symbol] )
f+=δf
η=e^{2πjf}

Phase Module (5)
Initialization Parameters
_φ_ a real number
_N_ a whole number
X=complex FIFO of size _N_
_μ_ a real number
Initialization
φ=_φ_
ρ=e^{2πjφ}
μ=_μ_
next(x)
X.append(x)
Return x·ρ
propagate(e)
Return e·ρ
update(e)
Note: The size of FIFO X was selected to be consistent with the size of the error vector e
δφ=2μI(ρ· [symbol] X|e [symbol] )
φ+=δφ
ρ=e^{2πjφ}

Decision Module (6)
Initialization Parameters
_C_ a complex constellation
Initialization
C=_C_
next(x)
Return argmin_{cϵC}|x−c|

Demodulation of a Dual-Channel Signal

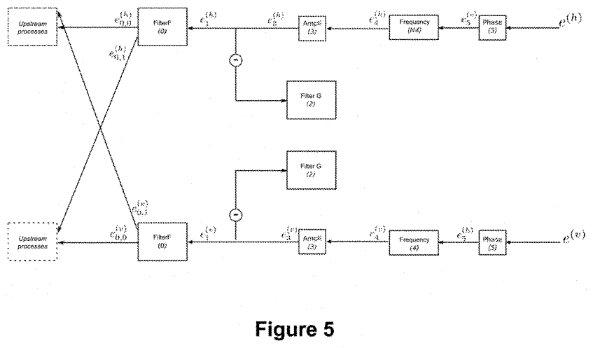

In some embodiments, the system for the blind demodulation of a multi-channel signal may operate based on the schematic configuration in FIGS. 4 and 5. FIG. 4 illustrates the succession of the processing blocks from the receipt of the two input samples (x₀^{(a)}; x₀^{(b)}), more particularly the succession of the function next( ) encapsulated (or integrated) in the sub-modules (or “mirror” block or residual block) of the system, denoted A-Nxx and/or H-Nxx for the first chain and B-Nxx and/or V-Nxx for the second chain. FIG. 5 illustrates the succession of the “propagate” and “update” processing blocks from the errors (e^{(h)}; e^{(v)}) calculated at the end of the processing chains, more particularly the succession of the propagate( ) and update( ) functions encapsulated in the sub-modules denoted Bxx, each of which groups together the update (Uxx) and propagate Pxx) sub-modules of the first (H) and second (V) processing chains. The first and second dual-channel processing chains are similar and can be placed in parallel (i.e., executed simultaneously).

The synchronizers or synchronization calculation block of the blind signal (A-N0) and (B-N0), at the start of the two processing chains, form the complex values x₀^{(a)} and x₀^{(b)}. These values can be input into the modules for correction of Phase (A-N1) and (B-N1), which each return a new complex value x₁^{(a)} and x₁^{(b)}. These values (x₁^{(a)} and x₁^{(b)}) can be input into the Filter modules (H-N1) and (V-N1). For example, as depicted in FIG. 4, the inputs between the two modules (Phase corrector module and Filter F module) are reversed.

At the first chain or chain H, the module (H-N1) forms an output 4). A difference is calculated: x₃^{(h)}=x₁^{(h)}−x₂^{(h)} to deliver an output x₃^{(h)}. The value x₂^{(h)} originating from the output of the Filter G (H-N2) module, bypass mounted. The output x₃^{(h)}, which can pass through the Amplitude (H-N4) module to deliver an output x₄^{(h)}, which can be input into the Frequency (H-N5) module. The Frequency module can deliver an output X₅^{(h)}, which can be input into the Phase (H-N6) module. The Phase module can deliver a complex value (or output) y^{(h)}. This value (x₁^{(h)}) constitutes the output of interest of the system and corresponds to the demodulated channel H.

The output symbol y^{(h)} can be input into a decision-making body (for example, a “slicer”) H-NL. This module is programmed with the constellation (or set of symbol points) of the modulation employed and returns for each y^{(h)} the complex value z^{(h)} of the point of the constellation closest to y^{(h)}.

A conjugated difference can be calculated: e^{(h)}=z̅^̅{̅(̅h̅)̅}̅−̅y̅^̅{̅(̅h̅)̅}̅ in order to constitute the first error of the chain H.

For example, in parallel, the value z^{(h)} can be sent into the feedback loop containing the filter G (H_N2). It can be multiplied successively by the conjugate of the internal value ρ of the phase module and by the conjugate of the internal value ρ of the next ( ) function of the frequency module to give a value z′^{(h)}. The values z′^{(h)} and z′^{(v)} constitute the inputs of the Filter G (H-N2) sub-module in order to be able to deliver outputs x₂^{(h)} and x₂^{(v)}.

The successions of the chain H applies similarly to the second chain or chain V (by replacing the exponents (h) by (v) in the references).

As depicted, for example, in FIG. 5, the errors e^{(h)} and e^{(v)} constitute the inputs of the error retro-propagation chain.

From the error e^{(h)} to the error e₁^{(h)} of the chain H and from the error e^{(v)} to the error e₁^{(v)} of the chain V, the error follows the same retro-propagation trajectory as in the case of the single-channel signal described above.

The Filter F sub-modules of the chain H (H-B1) and of the chain V (V-B1) each receive an error in the form of a complex number e₁^{(h)} or e₁^{(v)}, in order to update the different coefficients of the internal filters and to deliver two error vectors e_{0,0}^{(h)} and e_{0,1}^{(h)} and e_{0,0}^{(v)} and e_{0,1}^{(v)} in order to be able to obtain the errors e₁^{(a)} and e₁^{(b)} to retro-propagate in the Phase corrector sub-modules (A-B1 and B-B1). Thus, said vectors are therefore named according to: e₁^{(a)}=e_{0,0}^{(h)}+e_{0,1}^{(v)} and e₁^{(b)}=e_{0,0}^{(v)}+e_{0,1}^{(h)} so that the latter values can be input into the sub-module (A-B1) and the sub-module (B-B1), which can update the phase parameters, and then return (or deliver) the errors e₀^{(a)} and e₀^{(b)}. The errors e₀^{(a)} and e₀^{(b)} can be used to update the synchronization parameters in the sub-modules (A-B0) and (B-B1).

In some embodiments, each module of the calculation block of the network, by at least one hardware or a combination of hardware and firmware, may perform the following operations:

Filter F Module (1)
Initialization Parameters
N_{F} a whole number
Initialization
Fₐ=complex vector of size N_{F}
Fᵢ=complex vector of size N_{F}
X₀=complex FIFO of size N_{F}
X₀=complex FIFO of size N_{F}
next(x₀, x₁)
X₀.append(x₀)
X₁.append(x₁)
Return ( [symbol] F₀|X₀ [symbol] + [symbol] F₁|X₁ [symbol] )
propagate(e)
Return (e·F₀, e·F₁)
update(e)
δF₀=2μ×(̅e̅·̅X̅₀̅)̅ (here x is the term-to-term product of two vectors)
F₀+=δF₀
δF₁=2μ×(̅e̅·̅X̅₁̅)̅ (here x is the term-to-term product of two vectors)
F₁+=δF₁

Filter G Module (2)
Initialization Parameters
N_{G} a whole number
Initialization
G₀=complex vector of size N_{G}
G₁=complex vector of size N_{G}
x₀=complex FIFO of size N_{G}
X₁=complex FIFO of size N_{G}
next(x)
X.append(x)
Return ( [symbol] G₀|X₀ [symbol] + [symbol] G₁|X₁ [symbol] )
update(e)
δGₒ=2μ×(̅e̅·̅X̅₀̅)̅ (here x is the term-to-term product of two vectors)
G₀+=δG₀
δG₁=2μ×(̅e̅·̅X̅₁̅)̅ (here x is the term-to-term product of two vectors)
G₁+=δG₁

In some embodiments, the operations described for single-channel blind demodulation may be applied in the amplification, frequency, phase and/or decision modules.

Synchronizer

As described above, the blind demodulation system of the present invention may comprise an adaptive synchronizer (defined as “a synchronization calculation block of a blind signal” in the present application) for a demodulation chain of a linear modulation signal.

In some embodiments, the synchronizer comprises:
a first sub-module configured, via at least one processor and a software or executable code, to perform a function: next( ):Ø→complex to define and deliver its output signal;
a second sub-module configured to define a function: Update (w): complex→Ø through via at least one processor and a software or executable code, in order to estimate a corrective term (δτ).

The “next” function (a term to define moving to the next element of an iterator) of the first sub-module converts the input signal values to return the next sample on request. The “update” function of the second sub-module updates the corrective term to be applied to the estimation of the propagation delay in the input signal from an estimation of the error.

In some embodiments, the first sub-module of the synchronization block comprises a generator configured to extract sample values from the input signal as required. The signal is then seen as a sample generator, iterable and usable by the synchronization calculation block.

In some embodiments, the sample values extracted from the input signal are transmitted to a first buffer, placed in the first sub-module of the synchronization block, so as to store the last values of the signal. The first buffer can be placed in the first sub-module or in the synchronizer outside of the first sub-module, temporarily or permanently depending on the desired application.

In some embodiments, a second buffer is configured to store auxiliary values useful for calculating the corrective term (δτ). The second buffer can be placed in the second sub-module or in the synchronizer outside of the second sub-module, temporarily or permanently depending on the desired application.

In some embodiments, the first and second buffer are a memory buffer of FIFO type (“first-in-first-out”), defining a method for organizing and manipulating a data buffer, in which the first data input are processed first.

In some embodiments, an initialization function makes it possible to configure in order to initialize the parameters of the synchronization module or block.

Upon initiation, the synchronization module or block can take the following parameters:

The values of the sampling rate T_{iq} and the symbol rate T, one of the latter being set to 1
h and h′ are functions that make it possible to calculate the shaping filter of the signal and its derivative

An initial value of τϵ[0, T[; by default τ=0

A real parameter μ≥0 called learning rate and a priori small

A whole number n such that the time buffers described below have a size 2n+1

A whole number m such that the error w is a complex vector of size m

In some embodiments, the synchronizer can be initialized by at least a processor and at least a software or an executable code able to perform the following initialization operations:
\vec{t}=initialize the real number vector of size 2n+1

With \vec{t}[i]=(i−n)×Tiq+τ
\vec{X}=initialize FIFO buffer of complex numbers of size 2n+1 to 0
(\vec{Y}′)=initialize FIFO buffer of complex numbers of size m to 0

### Wherein

the value T_{iq} is the sampling rate
\vec{t} is the date vector corrected to return to 0
represents an evolutive variable
an initial value of τϵ[0, T[
a whole number n such that the buffers have a size 2n+1
a whole number m such that the error is a complex vector of size m

In some embodiments, the synchronization block can be configured to perform the following processes via at least one processor and at least one software or one executable code:
next( ):Ø→complex
\vec{t}=\vec{t}+T
While \vec{t}(n)>0
x=input.next( )
X.append(x)
\vec{t}=\vec{t}−T_{iq}
y= [symbol] \vec{X}|\vec{h}(\vec{t}) [symbol]
y′= [symbol] \vec{X}|\vec{h}′(\vec{t}) [symbol]
Y′.append(y′)
Return y
update(w):complex→Ø
δτ=2μ·R( [symbol] Y′|e [symbol] )
\vec{t}=\vec{t}+δτ

The “while” loop makes it possible to extract a set of samples (x) from the input generator and to integrate them into the first memory buffer. The vector t contains the dates of the samples contained in the buffer (X) related to the date of the next symbol transmitted by the synchronization block. As long as the date of the sample in the middle of the buffer is positive, a new sample is taken and the dates of the samples are updated until a sample of negative date is extracted. Once the criterion is verified (i.e., a negative sample extracted), the sequence of the processes to define the first output signal (y) can be followed.

The present invention has the advantage of using an adaptive synchronizer (i.e., a synchronizer comprising a synchronization calculation block of a blind signal) at the beginning of the chain, so that the rest of the chain is at a cadence reduced to one sample per symbol.

In some embodiments, the present invention distributes the compensation of the propagation channel over two filters, a “feedforward” filter denoted F and a “backward” filter denoted G. The combination of these two filters makes it possible to reinforce the equalization capacity of the demodulator, but requires the local addition of multipliers and conjugate operators to ensure optimal robustness to phase noise, frequency drifts and frequency instabilities in the dual-channel case.

The present invention also relates to a real-time method for the blind demodulation of digital telecommunication signals, based on the observation by sampling of a signal; this signal corresponds to the reception of a linear-modulation signal that has undergone deformations during transmission thereof, the processing process comprising the following steps:
acquisition by sampling of m₀ signals (x_{0,0}, . . . , x_{0,m}_{₀}₋₁) in order to each constitute an input of a network of specialized neurons; each neuron Fᵢ being simulated by the outputs of an upstream chain Gᵢ and stimulating a downstream chain Hᵢ; each set of samples passes through the same processing chain;
for each new sample input, each sub-neuron Fᵢ^{(N)} is stimulated by the outputs of the upstream chain Gᵢ^{(N)} formed of the cascade of specialized neurons F₀^{(N)} to Fᵢ₋₁^{(N)} and stimulating the downstream chain Hᵢ^{(N)} formed of specialized neurons Fᵢ₊₁^{(N)} to F_{L-1}^{(N)}; the processes carried out by the sub-module Fᵢ^{(N)} depend on a parameter stored internally θᵢ; the outputs of the last neuron F_{L-1}^{(N)} constitute the outputs of interest of the system or else the demodulated signals and are denoted y₀ . . . y_{N};
a nonlinear function (NL) is applied independently to each demodulated signal yⱼ in order to produce the variables (zⱼ) and calculate the errors at the chain end ϵⱼ=z̅ⱼ̅−̅y̅ⱼ̅;
retro-propagation of the error and updating of the parameter θᵢ;
an error signal passes through the network in the opposite direction: from the neuron F_{L-1} to the neuron F₀; the error input from the neuron F_{L-1} is the vector (e_{L-1,0}, . . . , e_{L-1,N-1})=(e₀, . . . , e_{N-1}); by passing through the neuron j, the error is modified by the sub-neuron Fⱼ^{(P)} before being transmitted to the neuron F₍ⱼ₋₁₎; in parallel to the retro-propagation of the error from the neuron j to the neuron j−1, the error from the neuron j+1 is input into the sub-neuron Fⱼ^{(U)}, which produces a corrective term δθᵢ, which makes it possible to update the internal parameter θᵢ according to θᵢ+=δθᵢ.

This calculated error can make it possible to correct the current value of θᵢ each block. The outputs of the last blocks of the network ideally correspond to the demodulated symbols.

These telecommunication signals can include deformations comprising, in particular: a channel filter (and a co-channel filter in the dual-channel case), an amplification, a phase value, a carrier leak, noise and other stochastic disturbances such as phase noise. Thus, according to the invention, the demodulation network will correct these different effects through specialized processing neurons. Specialized processing neurons are intended to mean one or more functions of which the parameters can be updated by retropropagation.

In some embodiments, the parameters θᵢ of the different processing blocks are initially predefined, for example arbitrarily without moving away from the expected values. For each sample entering the system and for each neuron i, our system produces a corrective term δθᵢ, which is added to the current value of the parameter θᵢ:θᵢ+=δθᵢ. This update equation produces a sequence of values of θᵢ, which converge on the value θᵢ, which makes it possible to best demodulate the input signal.

In some embodiments, each neuron Fᵢ of the network specifically carries out:
a processing of a “next” function, implemented and executed in the processing logic sub-block Fᵢ^{(N)} in order to generate outputs based on a plurality of observations and transmit them to the processing block of the next neuron in the network; for the neuron Fᵢ, this function is generally written with its inputs-outputs in the form (X_{i+1,0}, . . . , X_{i+1,m}_{ᵢ₊₁}₋₁)=next(X_{i,0}, . . . , X_{i,m}_{ᵢ}₋₁) with mᵢ the number of inputs and mᵢ₊ᵢ the number of outputs of Fᵢ^{(N)}, which corresponds to the number of inputs of Fᵢ₊₁^{(N)}. Each processing is configured parametrized by a set of parameters θᵢ hence the notation Fᵢ^{(N)}=Fᵢ^{(N)} (·|θᵢ) when one wants to recall the importance of parametrization. Each “Next” function is depicted in FIGS. 3 to 5 by a block Nᵢ;
a processing of a “Propagate” function, implemented and executed in the logic sub-block Fᵢ^{(P)} in order to calculate the errors (e_{i,0}, . . . , e_{i,m}_{ᵢ}₋₁) from the errors (e_{i+1,0}, . . . , e_{i+1,m}_{ᵢ₊₁}₋₁) provided by the block Fᵢ₊₁^{(P)} or by (e_{L-1,0}, . . . , e_{L-1,N-1})=(e₀, . . . , e_{N-1}) with eⱼ=z̅ⱼ̅−̅y̅ⱼ̅ at the chain end, i.e., at the input F_{L-1}^{(P)}. This function is written, for the i^{th} neuron: (e_{i,0}, . . . , e_{i,m}_{ᵢ}₋₁)=propagate(e_{i+1,0}, . . . , e_{i+1,m}_{ᵢ₊₁}₋₁). Each “Propagate” function is depicted in FIGS. 3 to 5 by a block Pᵢ referred to as residual block;
a processing of an “Update” function, implemented and executed in the “Update” logic sub-block Fᵢ^{(U)} in order to calculate the corrective term δθᵢ to be applied to the current value of the internally stored parameter θᵢ from the errors (e_{i+1,0}, . . . , e_{i+1,m}_{ᵢ₊₁}₋₁) returned by the sub-block Fᵢ₊₁^{(P)}. This function is generally written in the form δθᵢ=update(e_{i+1,0}, . . . , e_{i+1,m}_{ᵢ₊₁}₋₁). Each “Update” function is depicted in FIGS. 3 to 5 by a block Uᵢ referred to as residual block.

“Implemented and executed” is intended to mean either the execution of a program corresponding to the mathematical functions or formulae (explained in the text) by computing hardware (such as a microprocessor and a memory), or by hardware or a combination of hardware and firmware.

Thus, as depicted, for example, in FIG. 2b, each neuron Fᵢ encapsulates at least two logic sub-neurons, which each implement at least one of the two functions “update” and “next” hereafter and the “propagate” function, which is not necessarily implemented by the first block (Gᵢ):
Fᵢ^{(N)} implements (X_{i+1,0}, . . . , X_{i+1,m}_{ᵢ₊₁}₋₁)=next(X_{i,0}, . . . , X_{i,m}_{ᵢ}₋₁)

Fᵢ^{(P)} implements (e_{i,0}, . . . e_{i,m}_{ᵢ}₋₁)=propagate (e_{i+1,0}, . . . , e_{i+1,m}_{ᵢ₊₁}₋₁)
Fᵢ^{(U)} implements δθᵢ=update(e_{i+1,0}, . . . , e_{i+1,m}_{ᵢ₊₁}₋₁)

FIG. 1, for example, schematically depicts the integration of a “specialized neuron” Fᵢ in an upstream chain or set of neurons (Gᵢ) and in a downstream chain or set of neurons (Hᵢ) of a real-time method for the blind demodulation of digital telecommunication signals. The neuron Fᵢ is connected at the input to the last of the neurons of the set Gᵢ, and at the output of the first of the set Hᵢ.

In some embodiments, one of the processing blocks Fᵢ^{(N)} comprises at least one program implementing and executing a sequence of elementary processes of the form:
Fᵢ^{(N)} performs (X_{i+1,0}, . . . , X_{i+1,m}_{ᵢ₊₁}₋₁)=next(X_{i,0}, . . . , X_{i,m}_{ᵢ}₋₁), XᵢⱼϵK^{q}^{ᵢⱼ} with qᵢⱼ a whole number and K the real number space or the complex number space
Fᵢ^{(p)} performs (e_{i,0}, . . . , e_{i,m}_{ᵢ}₋₁)=propagate(e_{i+1,0}, . . . , e_{i+1,m}_{ᵢ₊₁}₋₁)
Fᵢ^{(U)} performs δθᵢ=update (e_{i+1,0}, . . . , e_{i+1,m}_{ᵢ₊₁}₋₁)

The processing performed by the block (Fᵢ^{(N)}) depends on a parameter θᵢ, which can be a real or complex number or a vector which is itself real or complex, etc.

In n some embodiments, the “Next” function implemented in the sub-neuron or sub-block Fᵢ^{(N)} is known analytically and depends on a parameter θᵢ.

It can be denoted (X_{i+1,0}, . . . ,X_{i+1,m}_{ᵢ₊₁}₋₁)=Fᵢ^{(N)}(X_{i,0}, . . . . X_{i,m}_{ᵢ}₋₁|θᵢ).

The elementary projections of the output vector on the component X_{i+1,j} can be denoted F_{i,j}^{(N)}.

In some embodiments, as depicted for example in FIG. 1, a network of specialized neurons (which can be arranged in a demodulator) for blind demodulation of a telecommunication signal with linear modulation comprises. in each of the neurons, a processing block (Gᵢ^{(N)}, Fᵢ^{(N)}, Hᵢ^{(N)}). The first processing block (Gᵢ^{(N)}) receives two signals each corresponding to a first plurality of observations of the signal in order to generate a plurality of outputs which are transmitted to the following logic block (Fᵢ^{(N)}). The logic block (Fᵢ^{(N)}) integrates the plurality of outputs to generate in turn another plurality of outputs which are transmitted to the last logic block (Hᵢ^{(N)}) of the network. This last block (Hᵢ^{(N)}) integrates in turn the plurality of outputs of the previous logic block (Fᵢ^{(N)}) in order to also generate a plurality of outputs. A nonlinear filter is applied to the output of the last block (Hᵢ^{(N)}), in order to calculate an error signal (e) to be able to retro-propagate it with this calculated error over each of the inputs of the network associated with the respective input of the network.

In some embodiments, the set of L blocks can execute a processing chain of the following form, implemented and executed by at least one program:

for every 0≤i<L

$$( y , … , {y}_{N - 1} ) = {H}_{i}^{( N )} ( {F}_{i , 0}^{( N )} ( {x}_{i , 0} … {x}_{i , {M}_{i} - 1} \vert {θ}_{0} ) , … , {F}_{i , {N}_{i} - 1}^{( N )} ( {x}_{i , 0} … {x}_{i , {M}_{i} - 1} \vert {θ}_{{n}_{i} - 1} ) \vert {θ}_{i + 1 : L - 1} )$$

$$With \\ ( {x}_{i , 0} , … , {x}_{i , {m}_{i} - 1} ) = {G}_{i}^{θ} ( {x}_{0 , 0} , … , {x}_{0 , {m}_{0} - 1} \vert {θ}_{0 : i - 1} ) = ( {G}_{i 0}^{θ} ( {x}_{0 , 0} , … , {x}_{0 , {m}_{0} - 1} \vert {θ}_{0 : i - 1} ) , … , {G}_{i , {m}_{1} - 1}^{θ} ( {x}_{0 , 0} , … , {x}_{0 , {m}_{0} - 1} {θ}_{0 : i - 1} ) )$$

A number of L blocks are chained in succession to perform an overall processing.

The succession of blocks 0 to i−1 is denoted Gᵢ^{(N)}( . . . |θ_{0:i-1}) and the succession of blocks i+1 á L−1 is denoted Hᵢ^{(N)}( . . . |θ_{i+1:L-1}). The outputs of the last block are denoted y₀, . . . , y_{N-1}.

F_{i,0}^{(N)} (x_{i,0} . . . x_{i,m}_{ᵢ}₋₁|θᵢ), . . . , F_{i,n}_{ᵢ}₋₁^{(N)}₁(x_{i,0} . . . x_{i,m}_{ᵢ}₋₁|θᵢ) is used to denote the nᵢ projection functions giving Y_{i,k}=F_{i,k}^{(N)}(X_{i,0} . . . x_{i,m}_{ᵢ}₋₁|θᵢ) for 0≤k<nᵢ.

In some embodiments, the variables on which each block output depends can be explained according to the following notation: yⱼ=yⱼ^{θ}(x_{0,0} . . . x_{0,M}_{₀}₋₁). Each block output can be a real or complex value or even a vector value.

In some embodiments, the addition of the nonlinearity at the output of the last block (e) of the network is executed by a function implemented in a program which is written:

zⱼ=NL(yⱼ)

wherein
zⱼ is the outgoing signal from a decision-making device in the last block
yⱼ is a demodulated sample

In some embodiments, the retropropagation of the calculated errors is obtained by the following processes, implemented and executed by an algorithm for retropropagation of the error:
initialization of the retropropagation in the form
   for 0≤k<N, e_{L,k}=z̅ₖ̅−̅y̅ₖ̅
Propagation of the error by the sub-neuron Fᵢ^{(P)} in the function (e_{i,0}, . . . , e_{i,m}_{ᵢ}₋₁)=propagate(e_{i+1,0}, . . . , e_{i+1,m}_{ᵢ₊₁}₋₁) according to the calculations

$$∀ 0 \leq j < {m}_{i} , {e}_{i , j} = {\sum }_{k} {e}_{i + 1 , k} \frac{\partial {F}_{i , k}}{\partial {x}_{i , j}}$$

In some embodiments, the updating of the internal parameters θᵢ of each neuron Fᵢ is obtained in the sub-neuron Fᵢ^{(U)} by the processes, implemented and executed in the function δθᵢ=update(e_{i+1,0}, . . . , e_{i+1,m}_{ᵢ₊₁}₋₁) according to:
Calculation of Δᵢ:

$$For 0 \leq j < {M}_{i + 1} {D}_{i , j} = {e}_{i + 1 , j} \cdot \frac{\partial {F}_{i , j}^{( N )}}{\partial {θ}_{i}}$$

Δᵢ=Σᵢ D_{i,j}
Updating of θᵢ:
θᵢ+=2μR(Δᵢ) if θᵢ is in an R vector space
θᵢ+=2μΔᵢ if θᵢ is in a C vector space

With
μᵢ a real parameter called “learning rate”
δθᵢ is the corrective parameter of the parameter θᵢ
Dᵢⱼ is an intermediate quantity of auxiliary calculations that can be temporarily stored in a memory or hardware registries implementing the embodiment
the θᵢ are stored temporarily.

In some embodiments, as the samples input into the system are processed by the different sub-neurons, the values of the different θᵢ, which may be arbitrarily initialized, converge on values making the demodulation effective.

In some embodiments, the network of specialized neurons constitutes a sequence of MIMO blocks (“multi inputs, multi outputs”), each block (i) performing a parameterized elementary processing by a set θᵢ. If all the θᵢ of the chain are correctly set, the chain proceeds with the effective demodulation of the signal.

In some embodiments, the parameters θᵢ are unknown, and the chain enables the in-line learning of the relevant values for each θᵢ. On initialization of the system, θᵢ are provided by default by a memory or buffer. In the first moments, the system enables the convergence of the θᵢ on relevant values; this phase is called the convergence phase; the demodulated signal produced at the output is thus not reliable. When the system reaches a vicinity of the parameters θᵢ, the process enters what is referred to as the production or monitoring phase. This means that the distances between the calculated values and those stored and defining a vicinity are less than certain pre-stored thresholds. The outputs of the demodulator are then reliable and usable together with the demodulation of the signal, the system continues with the variation of the parameters of the system. The system does not explicitly shift from one mode to the other; the second phase (or production phase) takes place as a continuation of the first.

In some embodiments, the method further comprises the storage by at least one buffer memory of the plurality of inputs and in at least one other buffer of the plurality of outputs of each specialized neuron of the network. The sample values extracted from the plurality of inputs of the signal can be transmitted into a first buffer, which may be associated with the corresponding processing block either temporarily or permanently depending on the desired application, so as to store the internal states of the input signal during an initiation phase. The values of the plurality of inputs can be stored in a second buffer which may be associated with a corresponding processing block either temporarily or permanently depending on the desired application, so as to store the internal states of the output signal.

In some embodiments, the memory buffers are of FIFO type (“First-In-First-Out”), defining a method for organizing and manipulating a data buffer, in which the first data input are processed first. Hereinafter, a FIFO memory buffer will be considered to be a vector. Thus, in some embodiments, the terms of the vector may go from the oldest (first index of the vector) to the most recent (last index of the vector) element of the FIFO buffer.

In some embodiments, the present invention can be applied equally in a blind context as well as in a non-blind one, but appears particularly beneficial in the former context. Indeed, this invention makes it possible to regulate a parameterizable processing chain without any prior knowledge. The invention is particularly relevant when several parameters are involved.

In some embodiments, a single-channel signal is defined as a linearly modulated digital signal transmitted by frequency transposition over a finite bandwidth. A dual-channel signal is defined as a pair of single-channel signals multiplexed over two orthogonal polarizations.

The method applied in a certain scheme makes it possible in particular to demodulate a single-channel signal of linear modulation by compensating: the amplification of the signal, its phase, its carrier leak, the effects of the propagation channel. The method applied according to another scheme to demodulate a dual-channel signal and to separate the two components thereof by compensating: the amplification of the signals, their phases, the carrier leaks, the effects of the propagation channel and the effects of the propagation co-channel (leak from one polarization to the other and vice-versa during the propagation of the signal).

Without losing the general nature and in order to simplify the explanations hereinbelow, it is possible for example to consider a single-channel signal to be a particular case of dual-channel signal.

In some embodiments, for example as depicted in FIGS. 3 to 5, the calculation principles of the method of the present invention in order to determine the filter(s), the amplification, the frequencies of the signal and the phase values of the signal can be executed in a blind demodulator of a signal of single-channel type and/or of a signal of multi-channel type.

In some embodiments, the method applied according to another scheme of the system makes it possible to demodulate a dual-channel signal and to separate the two components thereof by compensating: the amplification of the signals, their phases, the carrier leaks, the effects of the propagation channel and the effects of the propagation co-channel (leak from one polarization to the other and vice-versa during the propagation of the signal).

In some embodiments, these different steps of this method are therefore automatically performed continuously, in order to be able to optimize and self-regulate the calculations or operations carried out by the processing blocks (via at least one suitable algorithm) of the processing chain. This method for the blind demodulation of a signal of the present invention has the advantage of rapidly estimating in real time the different parameters of the signals transmitted and of setting up a suitable correction for each signal transmitted by retro-propagating it in the generic signal-processing chain. Moreover, the method of the present invention has the advantage of simply and effectively dealing with the problems associated with communication interception and preferably for the blind demodulation of telecommunication signals.

The present invention also relates to a computer program product implemented on a memory medium, capable of being executed within a computing processing unit by computing hardware (such as a microprocessor and a memory); either by hardware or a combination of hardware and firmware, and comprising instructions for executing a method according to any one of the previous embodiments.

In some embodiments, the present invention proposes an architecture of a network of “specialized” neurons in order to deal with the problems of communication interception and more particularly of blind demodulation of telecommunication signals.

Indeed, an input signal passes through a system having an aforementioned architecture to emulate a chain of specialized neurons; each neuron performs a particular function parametrized by a set of values. The values of the adjustments of each specialized neuron are unknown beforehand. A nonlinearity is applied to the result at the chain end, making it possible to calculate an “error”. It is then possible to retro-propagate this error in the processing chain as is done in neural network learning in order to evolve the value of each parameter of each block towards a more relevant value. Thus, in some embodiments, on initialization of the system, parameters θᵢ are provided by default by a memory of the device. In the first moments, the system enables the convergence of the θᵢ on relevant values; this phase is called the convergence phase; the demodulated signal produced at the output is thus not reliable. When the system reaches a vicinity of the parameters θᵢ, the system enters into the production or monitoring phase. This means that the distances between the calculated values and those stored and defining a vicinity are less than certain pre-stored thresholds. The outputs of the demodulator are then reliable and usable to apply them to other hardware or software or firmware elements making it possible to finalize the demodulation.

By this system, once it has arrived at the production or monitoring mode, the calculations are fewer and can be executed in parallel by the different elements actually forming the blocks and thus enabling real-time use.

The present invention further relates to a use in a system for the blind demodulation of a telecommunication signal. The system for blind demodulation (or searching) of the characteristics (or parameters) of the signal comprises at least one hardware or hardware and firmware architecture implementing a network of specific neurons.

In some embodiments, a first specialized neuron of the network performs the estimation of at least one filter enabling the blind acquisition of the signal and then a second performs at least one module making it possible to estimate the amplification of the signals in order thereafter to evaluate the other characteristics (or parameters) of the signals by the other neurons of the network. In some embodiments, the amplification module can be arranged in a neuron other than the first neuron. A second specialized neuron implements at least one frequency estimation module for determining the frequencies of the blind-transmitted signals and/or at least one phase module for determining the phase values of said signals. In some embodiments, the phase module can be arranged in a neuron other than the second neuron. A third specialized neuron implements a decision module for calculating an error signal and retro-propagating the errors calculated at each of the residual blocks of the previous neurons. The method according to any one of the previous embodiments is applied to determine the characteristics (or parameters) of the blind-transmitted signal (for example, the amplitude, the frequency, and the phase value of the signals).

In some embodiments, the method for blind demodulation can be applied in the case of the demodulation of a single-channel signal (as depicted for example in FIG. 3) and/or of a multi-channel signal (as depicted for example in FIGS. 4 and 5).

In some embodiments, for a signal of multi-channel type, aside from the demodulation of each channel, the method enables the blind separation of the different channels.

The present application describes various technical features and advantages with reference to the figures and/or various embodiments. A person skilled in the art will understand that the technical features of a given embodiment may in fact be combined with features of another embodiment unless the opposite is explicitly mentioned or it is not obvious that these features are incompatible or that the combination does not provide a solution to at least one of the technical problems mentioned in the present application.

In addition, the technical features described in a given embodiment may be isolated from the other features of this mode unless the opposite is explicitly stated.

It should be obvious for a person skilled in the art that the present invention allows embodiments in many other specific forms without departing from the scope of the invention as claimed. Therefore, the present embodiments should be considered to be provided for purposes of illustration, but may be modified within the range defined by the scope of the scope requested, and the invention should not be limited to the details provided above.

1.-24. (canceled)

25. A system for the blind demodulation of a linearly modulated digital telecommunication signal and comprising modules allowing the estimation, monitoring of the temporal variations and corrections in the value of the phases, amplitudes, frequencies, time offsets and a set of compensation filters of the propagation channel, characterized in that it comprises at least one hardware or hardware and firmware architecture comprising memories and one or more processing units for implementing a network of specific calculation blocks connected to each other, including
a block for the blind synchronization of the signal allowing the estimation, monitoring and compensation of the delay of the signal and also making it possible to adapt the processing rate of the downstream chain (of the demodulation system) to the reduced cadence of one sample per symbol,
a first block incorporates at least one module making it possible to estimate at least one of the parameters of the observed signals in order to subsequently evaluate the other parameters of the observed signals, by other calculation blocks of the network,
at least a second specialized calculation block incorporates a decision module in order to calculate an error signal and back-propagate the calculated errors to each of the residual blocks of the calculation blocks,
and in that the parameter of the first block is the amplification rate, and the system comprises an additional specialized block connected to the outputs from the first block and to the inputs for the decision block, this additional block comprising a calculation block within which at least one frequency estimation module is arranged for determining the frequencies of the blind-transmitted signals, and at least one additional calculation block connected to the outputs from the frequency calculation block of the additional block, in which a phase module for determining the phase values of said signals is arranged, and further in that it comprises an additional specialized block of the network between the synchronization block and the first calculation block, said additional block executes the estimation of at least one filter making it possible to correct all or part of the distortion induced by the propagation channel.

26. The demodulation system according to claim 25, characterized in that the synchronization block module is configured to receive as input a sampled complex signal flow with at least two samples per symbols and to store these samples in an internal memory buffer in order to deliver at each symbol time an output of the input signal to the downstream block in the network.

27. The demodulation system according to claim 25 or 26, characterized in that at least one filter module (F or G) of the additional block is initialized by the following initialization operations:
F=complex vector of size N_{F}
X=complex FIFO of size N_{F}
wherein the initialization parameters, stored in a memory of the filter module, are:
N_{F} is a whole number
μ a vector of real numbers of size N_{F}.

28. The demodulation system according to one of claims 25 to 27, characterized in that at least one amplification module of the first block is initialized by the following initialization operations:
a=_a_
X=complex FIFO of size _N_
μ=_μ_
wherein the initialization parameters, stored in a memory of the module of the first block, are:
_a_ is an initial amplification value
_N_ is a whole number
_μ_ is a real number.

29. The demodulation system according to one of claims 25 to 28, characterized in that the frequency estimation module of the additional block is initialized by the following initialization operations:
f=_f_
η=e^{2πjf}
ρ=1.0
X=complex FIFO of size _N_
μ=_μ_
wherein the initialization parameters, stored in a memory of the module of the additional block, are:
_f_is a real number coding an initial estimation of the frequency
_N_ is a whole number
_μ_ is a real number.

30. The demodulation system according to one of claims 25 to 29, characterized in that the phase value estimation module of the additional block is initialized by the following initialization operations:
φ=φ_φ
ρ=e^{2πjφ}
μ=_μ_
wherein the initialization parameters, stored in a memory of the module of the additional block, are:
_φ_is a real number
_N_ is a whole number
X=complex FIFO of size _N_
_μ_ is a real number.

31. The demodulation system according to one of claims 25 to 30, characterized in that, upon initialization of the system, parameters are provided by default by a memory of the system, allowing in the first moments, called the convergence phase, the convergence of the B on relevant values; then when the system reaches a defined vicinity of the parameters the system enters into the phase referred to as production or monitoring, the outputs of the demodulator system then are reliable and can be used to be applied to a use device or to other hardware or software or firmware elements making it possible to finalize the demodulation.

32. The system for the blind demodulation of a multichannel digital telecommunication signal according to one of claims 25 to 31, characterized in that each of the processing blocks (N1; H-N1; V-N1) of at least one of the two channels receives each of the two synchronized input signals (x₁^{(h)}; x₁^{(v)}) originating from the synchronization block, the signals x₃^{(h)} and x₃^{(v)} being representative of a correction applied to each signal xₒ by the respective output signals x₂^{(h)} and x₂^{(v)}, of each of the filters G of each channel, each emulated by a processing block (H-N2; V-N2), the signals x₃^{(h)} and x₃^{(v)} are sent to the serial cascades of the processing blocks (H-N4; V-N4), (H-N5; V-N5) and (H-N6; V-N6) of each channel, each emulating the signal indicating the amplification of the channel (ampli), for the block (H-N4; V-N4), respectively the frequency (fq) of the channel for the block (H-N5; V-N5) and respectively the phase (φ) of the channel for the block (H-N6; V-N6).

33. The system for the blind demodulation or searching of the parameters of multichannel digital telecommunication signals according to claim 32, characterized in that each respective output y^{h}, y^{v} of each processing block (H-N6; V-N6) emulating the phase correction of each channel H and V is sent to each decision block (H-NL; V-NL) of each channel and to each of the respective inputs of the back-propagation circuit of at least two errors (e^{h} and e^{v}) through the “mirror” blocks which allow the on-the-fly calculation of the increments of the different parameters of the blocks of the chain, the system comprising several processing modules of a plurality of observations of each input signal (xᵢ), each associated with an “Update” mirror or residual block for each phase, frequency and amplification parameter and a corresponding “Propagate” mirror or residual block for each phase, frequency and amplification parameter.

34. The system for the blind demodulation or searching of the parameters of multichannel digital telecommunications signals according to claim 32 or 33, characterized in that the output Z^{h}, Z^{v} of each decision block, is also sent to a pair of multipliers, receiving respectively, one from the phase block and the other from the frequency block fq; the output of the last multiplier of each channel is sent over each of the filters G of each channel, each emulated by a processing block of each channel.

35. A real-time method of separation and blind demodulation of digital telecommunication signals, based on the observation of a sampled version of this signal and comprising parameters, in particular the equalization coefficients, the value of the phase (φ), the amplitude of the signal, their frequency and their symbol time, this method comprising the following steps:
acquisition by a sampling of a first plurality of the signal in order to each constitute an input of a network of L processing blocks (Gᵢ, Fᵢ, Hᵢ) also referred to here as “specialized neurons”, each neuron being stimulated by the outputs of the preceding block, the first plurality of the signal being input into the first block stimulating a first neuron of the network in order to generate a plurality of outputs of the first block; each neuron Fᵢ being stimulated by the outputs of an upstream chain Gᵢ and stimulating a downstream chain Hᵢ; each set of samples passes through the same processing chain;
the outputs of the last blocks of the network ideally correspond to the demodulated symbols;
addition of a nonlinearity to each of the outputs of the last block of the network making it possible to calculate an error signal and propagation of this error in the reverse direction of the processing chain (“back-propagation”);
estimation upon receipt of the error by each neuron (i) of a corrective term δθᵢ and updating, in each block, of the value of the parameter θᵢ according to θᵢ+=δθᵢ, the method being characterized in that
each neuron (Fᵢ) of the network specifically carries out:
a processing of a “Next” function, implemented and executed in a processing logic sub-block (Fᵢ^{(N)}), in order to generate outputs based on a plurality of observations of the digital telecommunication signal and to transmit them to the processing logic sub-block (Hᵢ^{(N)}), of the processing block of the following neuron in the network; this function is generally written in the form (X_{i+1,0}, . . . , X_{i+1,m}_{ᵢ₊₁}₋₁)=next(X_{i,0}, . . . , X_{i,m}_{ᵢ}₋₁) with mᵢ the number of inputs and mᵢ₊₁ the number of outputs of Fᵢ^{(N)} which corresponds to the number of inputs of Fᵢ₊₁^{(N)};
a processing of a “Propagate” function, implemented and executed in a “Propagate” logic sub-block (Fᵢ^{(P)}) in order to calculate (e_{i+1,0}, . . . , e_{i+1,m}_{ᵢ₊₁}₋₁) errors provided by the block Fᵢ₊₁^{(p)} or by (e_{L-1,0}, . . . , e_{L-1,N-1})=(e₀, . . . , e_{N-1}) with eⱼ=z̅ⱼ̅−̅y̅ⱼ̅ at the chain end, i.e. at the input F_{L-1}^{(P)} for the i^{th} neuron, this function is generally written in the form (e_{i,0}, . . . , e_{i,m}_{ᵢ}₋₁)=propagate(e_{i+1,0}, . . . , e_{i+1,m}_{ᵢ₊₁}₋₁)
a processing of an “Update” function, implemented and executed in an “Update” logic sub-block (Fᵢ^{(U)}), in order to calculate corrective parameters δθᵢ to be applied to the current value of the internally stored parameter θᵢ from the errors (e_{i+1,0}, . . . , e_{i+1,m}_{ᵢ₊₁}₋₁) returned by the sub-block Fᵢ₊₁^{(p)}; this function is generally written in the form δθᵢ=update(e_{i+1,0}, . . . , e_{i+1,m}_{ᵢ₊₁}₋₁).

36. The method according to claim 35, characterized in that each neuron (Fᵢ) comprises at least one implementation and execution of a sequence of elementary processes of the form:
the sub-block Fᵢ^{(N)} performs(X_{i+1,0}, . . . , X_{i+1,m}_{ᵢ₊₁}₋₁)=next(X_{i,0}, . . . , X_{i,m}_{ᵢ}₋₁), XᵢⱼϵK^{q}^{ᵢⱼ} with qᵢⱼ whole number and K a real number space or a complex number space
the sub-block Fᵢ^{(p)} performs (e_{i,0}, . . . , e_{i,m}_{ᵢ}₋₁)=propagate(e_{i+1,0}, . . . , e_{i+1,m}_{ᵢ₊₁}₋₁)
the sub-block Fᵢ^{(U)} performs δθᵢ=update(e_{i+1,0}, . . . , e_{i+1,m}_{ᵢ₊₁}₋₁)

37. The method according to one of claims 35 to 36, characterized in that the addition of the nonlinearity to the output of the last block (Hᵢ^{(N)}) of the network is implemented by the function:
zⱼ=(yⱼ)
wherein
zⱼ is an outgoing signal from a decision-making device in the last block
yⱼ is an equalized or demodulated sample
the decision block being defined by the comparison of the result obtained by the output y of the phase block with a finite constellation of possible results stored by the decision block, and deciding to take, from the possible results, the one for which the distance with the representative point of the output y is the smallest.

38. The method according to claims 35 to 37, characterized in that the back-propagation of the calculated errors is obtained by the following processes, implemented and executed by an algorithm for back-propagation of the errors:
initialization of the back-propagation in the form
for 0≤k<Nₓ e_{L,k}=z̅ₖ̅−̅y̅ₖ̅
Propagation of the errors by the sub-neuron Fᵢ^{(p)} in the function (e_{i,0}, . . . , e_{i,m}_{ᵢ}₋₁)=propagate(e_{i+1,0}, . . . , e_{i+1,m}_{ᵢ₊₁}₋₁) according to the calculations
$$∀ 0 \leq j < {m}_{i} , {e}_{i , j} = {\sum }_{k} {e}_{i + 1 , k} \frac{\partial {F}_{i , k}}{\partial {x}_{i , j}}$$

39. The method according to claim 38, characterized in that the updating of the internal parameters θᵢ of each neuron Fᵢ is obtained in the sub-neuron Fᵢ^{(U)} by the processes, implemented and executed in the function δθᵢ=update(e_{i+1,0}, . . . , e_{i+1,m}_{ᵢ₊₁}₋₁) according to:
Calculation of Δᵢ:
$$For 0 \leq j < {M}_{i + 1} {D}_{i , j} = {e}_{i + 1 , j} \cdot \frac{\partial {F}_{i , j}^{( N )}}{\partial {θ}_{i}}$$
Δᵢ=Σⱼ D_{i,j}
Updating of θᵢ:
θᵢ+=2μR(Δᵢ) if θᵢ is in an R vector space
θᵢ+=2μΔᵢ if θᵢ is in a C vector space
With—μᵢ a real parameter called “learning rate”
δθᵢ is a corrective parameter of the parameter θᵢ
D is an intermediate quantity of auxiliary calculations that can be temporarily stored.

40. The method according to any one of claims 35 to 39, characterized in that as the samples input into the system are processed by the different sub-blocks, the arbitrarily initialized values of the different θᵢ converge on values making the demodulation effective.

41. The method according to any one of claims 35 to 40, characterized in that the network of specialized neurons constitutes a compatible sequence of blocks of MIMO (“multi inputs, multi outputs”) type.

42. The method according to one of claims 35 to 41, characterized in that it further comprises the storage, by at least one buffer memory, of the plurality of inputs and, in at least one other buffer, of the plurality of outputs of each specialized neuron of the network.

43. A computer program product implemented on a memory medium, executed within a computing processing unit and comprising instructions for implementing a method according to any one of claims 35 to 42.

44. The product for implementing a method according to any one of the preceding claims, characterized in that it comprises hardware or a combination of hardware and firmware, and comprising coded instructions for implementing the method according to any one of claims 35 to 42.

45. A use of a system for the blind demodulation of a telecommunication signal, the system comprising at least one network of specialized neurons each respectively defining a filtering by a first specialized neuron, an amplification gain by a second specialized neuron, a correction of the frequency of the digital telecommunication signal by a third specialized neuron, and a correction of the phase value of the signal by a fourth specialized neuron; for executing a method according to claims 35 to 42.
